(19) United States
(12) Patent Application Publication
(10) Pub. No.: US 2023/0173818 A1
(43) Pub. Date: Jun. 8, 2023

(54) Inkjet Ink System for Handling High Solid Particles Loaded Inks

(71) Applicant: Ferro Corporation, Mayfield Heights, OH (US)

(72) Inventors: Michael Dorvat, Kfar Saba (IL); Yaniv Kiffel, Kfar Saba (IL); Arnon Lewartowski, Kfar Saba (IL); Oren Suchoi, Kfar Saba (IL); Omri Ben Harush, Kfar Saba (IL); Efraim Miklatzky, Kfar Saba (IL)

(21) Appl. No.: 17/925,689

(22) PCT Filed: May 19, 2021
(86) PCT No.: PCT/US2021/033270

§ 371 Date: Nov. 16, 2022

Related U.S. Application Data
(60) Provisional application No. 63/026,069, filed on May 17, 2020.

(51) Int. Cl. B41J 2/175

(52) U.S. Cl. CPC B41J 2/17566; B41J 2/17596; B41J 2002/17576; B41J 2002/17579; B41J 2002/17583; B41J 2002/17573

(57) ABSTRACT

The application describes an ink delivery system for an inkjet printer. The system includes a first ink tank operative to supply ink to at least one inkjet printhead and a second ink tank operative to receive ink flown through at least one printhead and not used by at least one printhead. The ink for printing is drawn by low pressure from a first tank through the printhead to a second ink tank. Each of the ink tanks includes a cylindrical tubular segment and a segment with a frustoconical inner section.

### TECHNOLOGY FIELD

The apparatus and method are related to the field of inkjet printing on glass substrates, and particularly to process of maintaining the ink in suitable physical properties to be printed.

### BACKGROUND

Inkjet printing technology generates images by ejecting small ink droplets onto a substrate from a printing head (printhead) assembly. Inkjet printing is a versatile printing method, and the image could be deposited on a wide variety of materials. Besides printing on paper, inkjet printing devices are used to print on such substrates as wood, ceramics, metal, and glass. The ink for inkjet printing may contain inorganic pigment particles, solvents, stabilizers, and some other ink ingredients. The inks for printing on glass contain sub-micron glass frit particles.

The sub-micron glass particles and inorganic pigments are later fused or fired into the glass substrate during the glass tempering or annealing process. The fusing of ink into the substrate supports the creation of vivid, durable designs that can last as long as the substrate lasts. The pigments provide ink with a specific color.

The printheads include a plurality of ink droplets ejecting nozzles. Typically, an ink reservoir or tank supply ink to the printhead. The printed image determines the operation of the printhead nozzles. Not every nozzle constantly ejects ink droplets. Unjetted ink returns to the ink supply tank. Maintaining the ink parameters constant supports consistent printing results. In some printers, inks are continuously stirred to support a continuous flow in a cycle from the ink reservoir to the smaller printhead chambers (and nozzles in some cases) and back to the main tank again.

The sub-micron glass and pigment particles are four to five times heavier than organic particles. Inorganic, high-density particles rapidly precipitate, clog the ink path, the nozzles of the inkjet printhead, and require constant ink agitation or circulation. These ink precipitations lead to print inhomogeneity and even to system blockages. For these reasons, inkjet printers for inks containing particulate materials, such as inks for printing on glass or ceramic materials, generally include systems for ink circulation and agitation to prevent these problems. These requirements necessarily result in hardware and maintenance costs, as well as ink wastage.

The following U.S.A., European and Japanese patents disclose different ink circulation systems: US20100232827, US 20100085405; US 20110234711; US 20120194619; U.S. Pat. No. 8,608,300; U.S. Pat. No. 8,926,077; DE60025095; EP 3159174; JP25088599; and WO2019/117697.

### DEFINITIONS

A frustum is the basal part of a cone or pyramid formed by cutting off the top by a plane parallel to the base of the shape. As used in the present description frustoconical and frustopyramidal, means truncated cone and a truncated pyramid.

A high load ink is an ink that contains a high proportion of solid particles. An example of high solid particle load ink could be an ink used in printing on glass applications. Typically, such ink contains more than 40% particles by weight and even up to 80% by weight of solid particles.

As used in the present disclosure, the term “image content” means a percentage of a printed area occupied by an image. For example, image content of 15% requires significantly less ink than image content of 60% requires.

Ink sloshing is the periodic or random motion of the free surface of liquid ink in a partially filled ink tank. Sudden acceleration or braking of the ink tank causes the ink sloshing.

### SUMMARY

An ink delivery system for an inkjet printer including a first ink tank operative to supply ink to at least one inkjet printhead, a second ink tank operative to receive ink flown through at least one printhead and not used by at least one printhead. Each of the ink tanks includes a cylindrical tubular segment and a segment with frustoconical inner section. The cylindrical segment and the segment with frustoconical inner section of the ink tank extend in the same direction.

A negative pressure draws ink for printing from a first ink tank through the printhead to a second ink tank ink. The first ink tank of the ink delivery system provides ink to one or more printheads. Each of the ink tanks of the ink delivery system includes a minimum ink level sensor; and a maximum ink level sensor. The first ink tank minimum level sensor activates a pump delivering ink from the second ink tank into the first ink tank. The maximum ink level sensor is operative to dispose of excessive ink and prevent ink flooding. Each of the ink tanks includes at least one sloshing reducing baffle.

The ink delivery system continuously circulates the ink within the ink system. The continuous ink circulation prevents the formation of ink stagnation points, and the ink flow is sufficient to support nozzle recovery and air from ink removal. The ink delivery system includes an ink drain channel and supports ink from system evacuation and ink system cleaning.

Disclosed is also a method of using the ink delivery system for simultaneously delivering ink to one or more inkjet printheads in an inkjet printing system.

### LIST OF DRAWINGS AND THEIR BRIEF DESCRIPTION

Particular examples of the ink delivery system will now be described, with reference to the accompanying drawings, in which the same reference numeral designates the common elements in the various figures, and in which:

FIG. 1 is an elevation view of an example of a highly loaded particulate ink delivery system for an inkjet printer;

FIG. 2A is an example of an ink tank including a segment with a spherical inner surface;

FIG. 2B is an example of an ink tank including a segment with a parabolic inner surface;

FIG. 3 provides additional details of the highly loaded particulate ink delivery system;

FIG. 4 provides further details of the highly loaded particulate ink delivery system;

FIG. 5 is a top view of an example of the particulate ink delivery system illustrating operation of the ink sloshing prevention baffles; and

FIG. 6 is a flowchart illustrating ink from ink delivery system evacuation.

### DESCRIPTION

Inkjet printing technology generates images by ejecting from a printing head (printhead) assembly small ink droplets onto a substrate. A computer that includes a raster image processor implemented in software or hardware governs the process of ink droplets ejection. Ink is continuously supplied to a printhead that ejects ink droplets to form an image. The print head or an assembly of printheads may not use all of the ink provided by the ink flow from an ink storage tank. Image content defines the amount of ink used. As a result, the unused ink may flow back into the ink tank. The unused ink, however, is not identical in the properties to the ink in the ink storage tank, and some auxiliary systems maintaining the ink composition are usually included in the unused ink flow.

The inks for printing on glass contain sub-micron glass frit and pigment particles. These particles are four to five times heavier than organic particles. The sub-micron particles rapidly precipitate, clog the ink path, the nozzles of the inkjet printhead, and require constant ink agitation or circulation. Although the ink circulation may reduce the rate of solid particle precipitation, it may not eliminate the solid particles precipitation process.

The present disclosure suggests a simple ink delivery system suitable for regular inks and, in particular, for inks containing a large percentage of particulate materials, such as inks for printing on glass or ceramic materials.

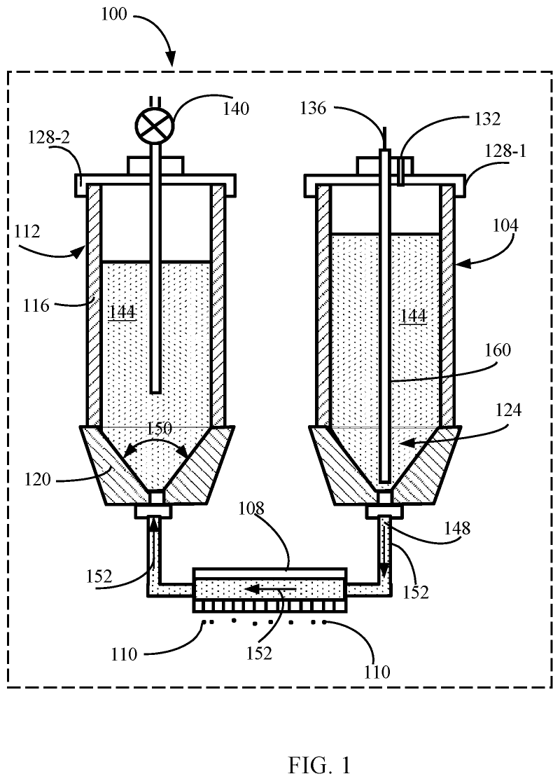

FIG. 1 is an elevation view of an example of a highly loaded particulate ink delivery system for an inkjet printer. System 100 includes a first ink tank 104 an inkjet printhead 108 and a second ink tank 112. Ink is illustrated by a dotted volume 144. In one example, the body of the first and second ink tanks each include a cylindrical tubular segment 116 and a segment 120 with a frustoconical inner section 124 having conical surfaces. In another example, the cylindrical tubular segment could be replaced by a prismatic tubular segment with a different number of facets, a tubular segment with oval crosssection, and other symmetric or asymmetric shapes, including asymmetric conical shapes. The number of facets of the prismatic tubular segment could be three, five, eight, or more. In some examples, a segment with frustopyramidal inner section could replace segment 120 with frustoconical inner section 124.

The cylindrical tubular segment 116 and segment 120 with frustoconical inner section 124 of each of the ink tanks 104 and 112 could be rigidly connected between them. In some examples, a gasket could be inserted between the cylindrical segment 116 and a segment 120 with a frustoconical inner section 124. The axes of cylindrical tubular segment 116 and segment 120 with frustoconical inner section 124 extend in the same direction and could be coaxial, collinear, or even oriented at a certain angle to each other.

A cover or a lid 128-1 with an opening 132 allowing ingress of ambient air covers first ink tank 104. A tube 160 terminated by a fitting 136 supports ink or cleaning fluid entry and evacuation from first ink tank 104. A vacuum valve 140 supports fluid communication with a generator of negative pressure, which could be a vacuum pump. Vacuum valve 140 is mounted on a cover 128-2 of a second ink tank 112. The negative pressure developed by the generator of negative pressure generates a difference in pressure between the first 104 and second ink tank 112. The difference in pressure draws the ink for printing from the first tank 104 through the printhead 108 to the second ink tank 112. The negative pressure that draws the ink from the first tank through the printhead to the second ink tank is between −0.05 to −0.5 bar. The ink flow caused by the negative pressure is sufficient to support nozzle recovery and air from ink removal, usually termed as ink degassing.

Ink outlet 148 of the first ink tank 104 supplies or provides ink to one printhead; although, the ink outlet could be configured to provide ink to two, four, eight, or sixteen printheads 108. Arrows 152 show the ink flow from the first ink tank 104 through the printhead to the second ink tank 112. Each time the ink is circulated through the ink delivery system, the ink passes through printhead 108. When operated, printhead 108 ejects ink droplets 110 towards a substrate (not shown). A computer (not shown) that includes a raster image processor implemented in software or hardware governs the process of ink droplets 110 by printhead 108 ejections according to the image content.

The frustoconical segment 120 has no horizontal surface and does not accumulate sediments. Angle 150 of the frustoconical section could be between 20 to 160 degrees and frequently between 45 to 100 degrees. The percentage of solid particles in ink (ink load) influences angle 150 value selection. Angle 150 is selected to avoid ink sedimentation as a function of ink load, and in addition to the ink, load considers ink viscosity, types of pigments used, and other factors.

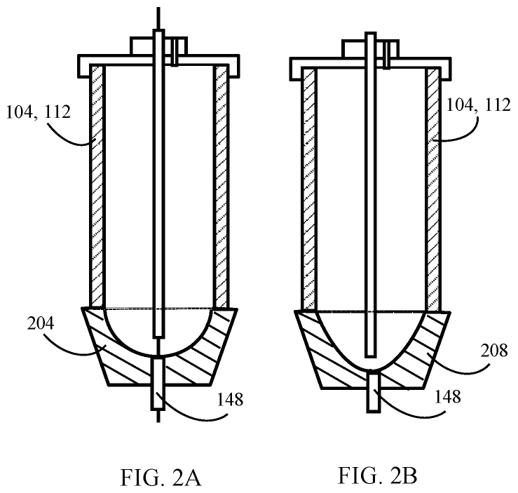

The connection of the segment 120 with a frustoconical inner section 124 with the cylindrical tubular section of the ink tank is selected to facilitate sediments slide towards the ink outlet/s located at the bottom of frustoconical inner section 124. In some examples, segment 120 with inner frustoconical section 124 could be replaced by a segment with a spherical inner section 204 (FIG. 2A), or a segment with a parabolic inner section 208 (FIG. 2B). Both a spherical inner section 204 and parabolic inner sections are concave surfaces. Other surfaces, including convex surfaces facilitating sediments slide towards the ink outlet/s 148, could be considered.

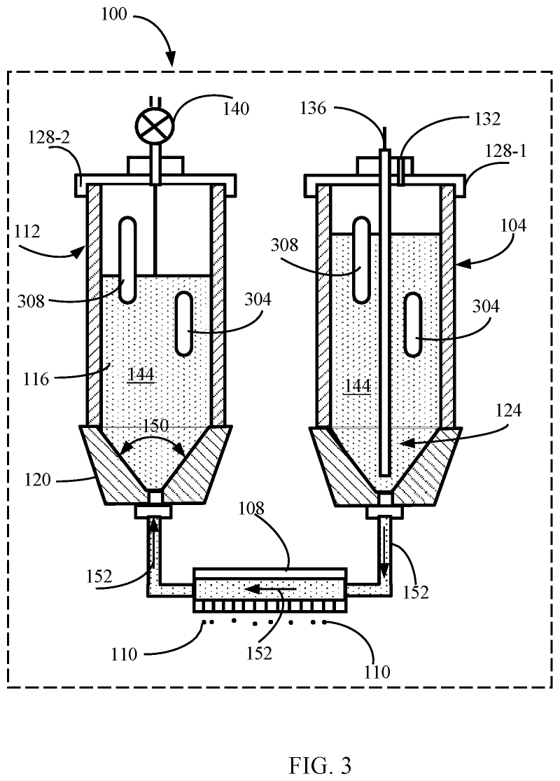

FIG. 3 provides additional details of the highly loaded ink delivery system. Each of ink tanks 104 and 112 of the ink delivery system 100 includes a minimum ink level or low level sensor 304 and a maximum ink level or overflow level sensor 308. The minimum ink level sensor 304 and the maximum ink level sensor 308 could be one of a group of sensors consisting of floating sensors, magnetic reed switch-based floats, solid-state electro-optical switches, conductivity sensors, capacitive, ultrasonic, and piezo-resonant switches. Sensors 304 and 308 could be attached to the ink tank covers 128-1 and 128-2 or attached to the inner cylindrical surface of ink tanks 104 and 112. Sensors 304 and 308 could be of the same type or different types.

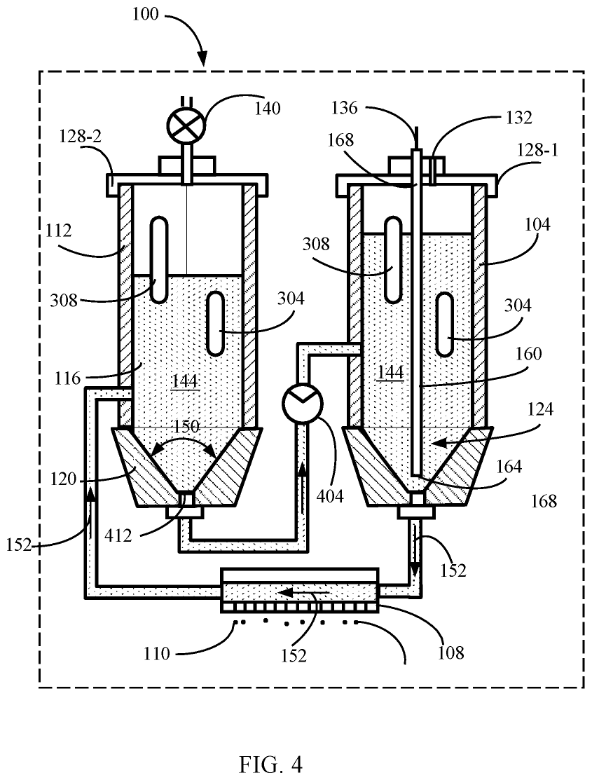

In the course of regular ink delivery system operation, as shown by arrows 152 (FIG. 1 and FIG. 4), the ink flows from the first ink tank 104 through printhead 108 to second ink tank 112. Each time the highly loaded ink circulates through the ink delivery system, the ink passes through printhead 108 and segment 120 with frustoconical inner section 124. When operated, printhead 108 ejects ink droplets 110 towards a substrate (not shown). When the ink level in the first ink tank 104 reaches a low or minimum ink level, the minimum ink level sensor 304 of the first ink tank 104 activates a pump 404, delivering ink from the second ink tank 112 into the first ink tank 104. The maximum ink level sensor 308 is operating to dispose of excessive ink and prevent ink flooding.

The use of ink level sensors 304 and 308 supports the reliable detection and monitoring of ink levels in the ink tanks 104 and 112. The process of delivering ink by pump 404 from the second ink tank 112 into the first ink tank 104 supports continuous ink circulation in the ink delivery system.

The ink delivery system, wherein the segment 120 with frustoconical inner section 124 has no surfaces where solid particles could accumulate, facilitates continuous ink circulation, and prevents the formation of ink stagnation points.

The ink delivery system 100 could also include a main ink 512 and 508 tank (not shown). The main ink tank supports the initial filling of the ink into the ink delivery and circulation system 100 as well as additional ink filling cycles to the first and second ink tanks 104 and 112 caused by ink in the course of printing depletion.

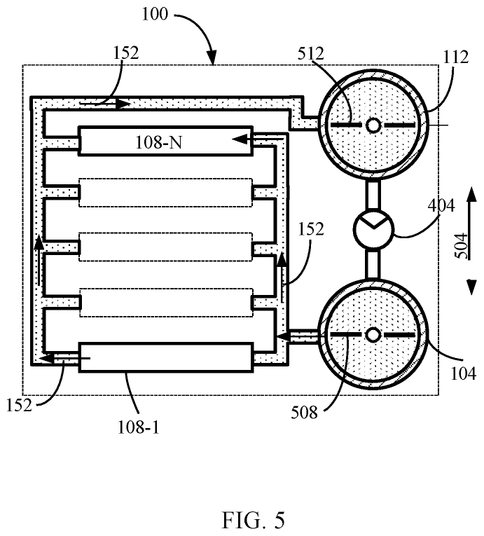

Typically, the ink delivery system 100 would be mounted on a carriage moving back and force over a substrate. Ink delivery system 100 mounted on the carriage could be oriented at any angle concerning carriage movement direction 504. When the carriage accelerates or decelerates or changes the movement direction, ink sloshing could occur. Ink sloshing affects the quality of printing and changes sensors 304 and 308 readings. To mitigate the ink sloshing effect influence on the print quality, the ink delivery system includes ink sloshing, reducing baffles 504 and 508 mounted in each of the respective ink tanks 104 and 112 (FIG. 5). The orientation of ink sloshing, reducing baffles 508 and 512, is such that the baffle's surface is perpendicular or almost perpendicular to the direction of the carriage movement. Such orientation of the ink sloshing, reducing baffles 508 and 512 allows mitigation or even cancellation of the ink sloshing effects.

There could be a need to change the ink in the ink delivery system on another ink or clean the ink delivery system 100. Ink delivery system 100 (FIG. 4) further includes an ink drain channel, which could be a tube 160 one end 164 of which is proximal to bottom of the first ink tank 104, and the distal end 168 through fitting 136 connects to a source of negative pressure generator or a pump.

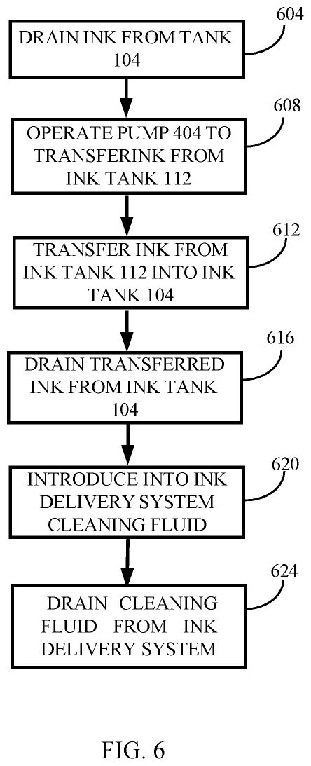

FIG. 6 is a flowchart illustrating ink from ink delivery system evacuation. Initially, the ink through ink drain channel or tube 160 is drained or evacuated (Block 604) from the first ink tank 104. Pump 404 becomes operative (Block 608) to transfer remaining in ink tank 112 and printhead 108 ink (Block 612). Second ink tank 112 includes an ink drain outlet 412 (FIG. 4) through which pump 404 (FIG. 4) removes ink from the ink tank 112 and transfers the removed ink into already free of ink first ink tank 104. The ink transferred into the first ink tank 104 is removed from the first ink tank 104, as explained above through the ink drain channel or tube 160 (Block 616). The ink transfer and removal cycle continues as necessary until all of the ink is completely removed from the ink delivery system 100.

A solvent or an ink cleaning fluid could be used to clean the ink delivery system 100. The solvent fills-in the ink delivery system through an ink drain channel or tube 160 and removed or evacuated from the system as described above.

It should be appreciated that the various features of the examples that have been described could be combined in various ways to produce numerous additional examples of the ink delivery system. Accordingly, the ink delivery system is not to be limited by those specific examples and methods described herein and include alternatives, modifications, and equivalents falling within the scope of the appended claims.

1-26. (canceled)

27. An ink delivery system for an inkjet printer, comprising:
a first ink tank operative to supply ink to at least one inkjet printhead;
a second ink tank operative to receive ink flowing through the at least one inkjet printhead and not used by said at least one inkjet printhead;
a negative pressure generator generating a negative pressure between said first ink tank and said second ink tank; wherein
a body of each of the first and the second ink tanks includes a cylindrical segment and a segment with frustoconical inner section; and wherein the ink for printing is drawn from the first ink tank through the printhead to the second ink tank.

28. The ink delivery system of claim 27, wherein at least one of the first and second inks tank include:
a minimum ink level sensor; and
a maximum ink level sensor.

29. The ink delivery system of claim 28, wherein the minimum ink level sensor and the maximum ink level sensor are each independently selected from the group consisting of floating level sensors, magnetic reed switch-based floats, solid-state electro-optical switches, conductivity sensors, capacitive switched, ultrasonic switches, and piezo-resonant switches.

30. The ink delivery system of claim 27, further comprising a pump, wherein the minimum level sensor activates said pump delivering ink from the second ink tank into the first ink tank.

31. The ink delivery system of claim 27, wherein the first ink tank supplies ink to at least one printhead.

32. The ink delivery system of claim 27, wherein each of the first and the second ink tanks include at least one ink sloshing reducing baffle.

33. The ink delivery system of claim 27, wherein the cylindrical segment of the ink tank is rigidly coupled to the segment with frustoconical inner section of the ink tank.

34. The ink delivery system of claim 27, further comprising at least one ink outlet; wherein
the first ink tank operates to supply ink to the at least one inkjet printhead; and wherein
the first ink tank supplies ink through the at least one ink outlet located at a narrow part of the segment with frustoconical inner section.

35. The ink delivery system of claim 27, further comprising at least one of an ink circulation system and an ink agitation system.

36. The ink delivery system of claim 27, wherein the angle 150 of the frustoconical segment is from about 20 to about 160 degrees.

37. The ink delivery system of claim 27, wherein a pressure differential draws the ink from the first ink tank through the printhead to the second ink tank.

38. The ink delivery system of claim 37, wherein the pressure differential is a negative pressure of −0.05 to −0.5 bar that draws the ink from the first ink tank through the printhead to the second ink tank.

39. The ink delivery system of claim 27, wherein
at least one of the first and second ink tanks further comprise:
a minimum ink level sensor;
a maximum ink level sensor; wherein
the minimum ink level sensor and the maximum ink level sensor are each independently selected from the group consisting of floating level sensors, magnetic reed switch-based floats, solid-state electro-optical switches, conductivity sensors, capacitive switched, ultrasonic switches, and piezo-resonant switches;
and wherein the ink delivery system further comprises:
a pump, wherein the minimum ink level sensor activates said pump to deliver ink from the second ink tank into the first ink tank;
at least one of an ink circulation system and an ink agitation system; and
at least one ink sloshing reducing baffle.

40. A method of delivering ink to an inkjet printhead in an inkjet printing system, comprising:
providing an inkjet printing system including a first ink tank, a second ink tank and at least one inkjet printhead; wherein
at least one of the first and second ink tanks comprises a body including a cylindrical segment and a segment with frustoconical inner section; wherein
each ink tank further comprises a minimum ink level sensor and a maximum ink level sensor; wherein
the minimum ink level sensor operates a pump to transfer ink from the second ink tank into the first ink tank, and
generating a difference in pressure between the first and the second ink tank; wherein the difference in pressure draws ink from the first ink tank through the printhead to the second ink tank.

41. The method of claim 40, wherein the maximum ink sensor level disposes of excess ink.

42. The method of claim 40, further comprising employing a pressure generator operative to generate a pressure difference between the first and the second ink tanks.

43. The method of claim 40, wherein the pressure difference is −0.05 to −0.5 bar, that draws the ink from the first ink tank through the printhead to the second ink tank.

44. The method of claim 40, further comprising draining the ink delivery system through at least one of a drain channel of the first ink tank and an ink drain outlet of the second ink tank.

45. The method of claim 40, wherein an ink includes at least 40% of solid particles.

46. A method of circulating ink in an inkjet printing system, comprising:
providing an inkjet printing system including a first ink tank, a second ink tank and at least one inkjet printhead;
generating a difference in pressure between the first and a second ink tanks and
wherein the difference in pressure draws ink from the first tank through the printhead to the second ink tank; wherein
the first and second ink tanks each have a body including a cylindrical segment and a segment with a frustoconical inner section; wherein
each ink tank further includes a minimum ink level sensor and a maximum ink level sensor; and wherein
a minimum ink level sensor operates a pump which transfers ink from the second ink tank into the first ink tank.
